(19) United States
(12) Patent Application Publication
(10) Pub. No.: US 2014/0085411 A1
(43) Pub. Date: Mar. 27, 2014

(54) ELECTRONIC DEVICE AND METHOD FOR CAPTURING PANORAMIC IMAGE

(71) Applicant: HON HAI PRECISION INDUSTRY CO., LTD., New Taipei (TW)

(72) Inventors: BING-NONG HUANG, New Taipei (TW); TUAN-YANG LI, New Taipei (TW)

(73) Assignee: HON HAI PRECISION INDUSTRY CO., LTD., New Taipei (TW)

(21) Appl. No.: 14/024,634

(22) Filed: Sep. 12, 2013

(30) Foreign Application Priority Data
Sep. 21, 2012 (TW) 101134641

(51) Int. Cl. H04N 5/232

(52) U.S. Cl. CPC H04N 5/23238
USPC 348/37

(57) ABSTRACT

In a method for capturing a panoramic image by using an electronic device, the electronic device receives preview images from an image capturing device. The electronic device controls the image capturing device capturing images corresponding to the preview images, and obtains the images from the image capturing device. Once the electronic device acquires a predetermined number of continuous images captured by the image capturing device at a predetermined number of continuous capturing angles, the electronic device stitches the predetermined number of continuous captured images into a panoramic image.

### BACKGROUND

1. Technical Field

Embodiments of the present disclosure relate to image capturing technology, and more particularly to an electronic device and a method for capturing a panoramic image using the electronic device.

2. Description of Related Art

Generally, when a user captures a panoramic image using an image capturing device, the user first fixes the image capturing device on a tripod. As a panoramic image is stitched together by a predetermined number of continuous images at a predetermined number of continuous capturing angles. When a first image at a first capturing angle is captured by the image capturing device, the user manually adjusts position of the image capturing device from the first capturing angle to a second capturing angle, to capture a second image at the second capturing angle, which is to be stitched with the first image. Thus, it is not convenient for the user to manually adjust the capturing angle of the image capturing device. What is needed, therefore, is a system and a method of capturing panoramic image.

### BRIEF DESCRIPTION OF THE DRAWINGS

FIG. 1 is a block diagram of one embodiment of an electronic device including a capturing system, which is in electronic connection with an image capturing device.

FIG. 2 is a flowchart of one embodiment of a method for capturing a panoramic image.

FIG. 3 illustrates one embodiment of a display of the electronic device displaying a captured image and a preview image simultaneously.

FIG. 4A illustrates one example of adjusting the image capturing device from a first capturing angle to a second capturing angle.

FIG. 4B illustrates another example of adjusting the image capturing device from the first capturing angle to the second capturing angle.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

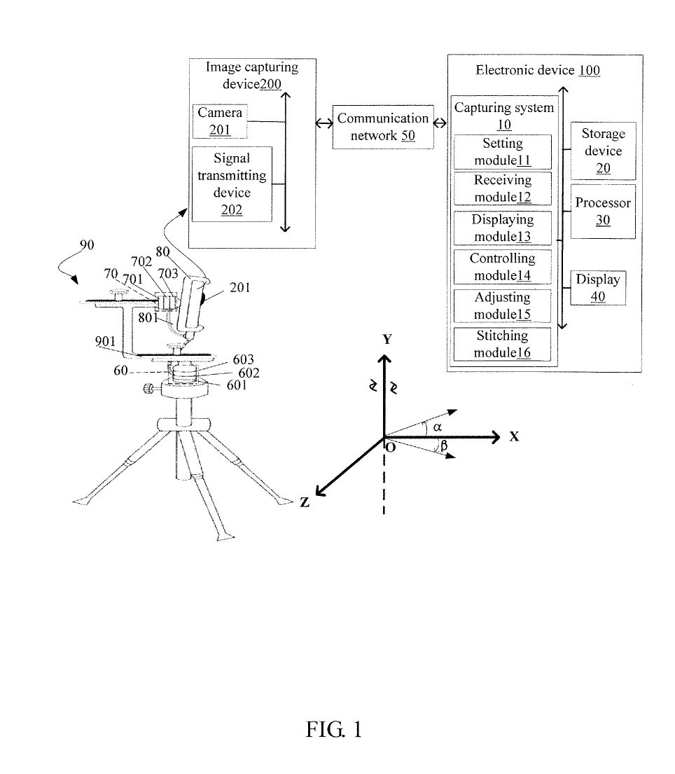

FIG. 1 is a block diagram of one embodiment of an electronic device 100 including a capturing system 10. The electronic device 100 may be a mobile phone, a personal digital assistant (PDA), or other computing device. The electronic device 100 is in communication with an image capturing device 200 through a communication network 50. The electronic device 100 further includes a storage device 20, at least one processor 30, and a display 40.

In one embodiment, the capturing system 10 is used to control a camera 201 of the image capturing device 200 to capture images. The display 40 is used to display the images sent from the image capturing device 200, through the communication network 50. In one embodiment, the display 40 displays a preview image and a captured image acquired from the image capturing device 200 simultaneously. The preview image and the captured image can be juxtaposed together in one example.

The image capturing device 200 further includes a signal transmitting device 202, and the image capturing device 200 may be fixed to a tripod 90 by a clamp 80. The signal transmitting device 202 is connected to a first direction controlling device 60 and a second direction controlling device 70 of the tripod 90 through a wire cable 801.

In one embodiment, the first direction controlling device 60 includes a first circuit board 601, a first motor 602, and a first drive gear 603 connected to a main part 901 of the tripod 90. The second direction controlling device 70 includes a second circuit board 701, a second motor 702, and a second drive gear 703 connected to the clamp 80.

The first direction controlling device 60 is used to rotate the image capturing device 200 clockwise or counterclockwise around a Y-axis of an exemplary coordinate system as show in FIG. 1. The second direction controlling device 70 is used to raise or lower the image capturing device 200.

For example, when the electronic device 100 sends a first predetermined adjustment signal to rotate the image capturing device 200 clockwise or a second predetermined adjustment signal to rotate the image capturing device 200 counterclockwise, to the image capturing device 200, the signal transmitting device 202 transmits the first and the second predetermined adjustment signals to the circuit board 601. Then the first circuit board 601 controls the first motor 602, which drives the main part 901 to rotate the image capturing device 200 around the Y-axis clockwise or counterclockwise using the first drive gear 603.

When the electronic device 100 sends a third predetermined adjustment signal of raising the image capturing device 200, or a fourth predetermined adjustment signal of lowering the image capturing device 200, to the image capturing device 200, the signal transmitting device 202 transmits the third and fourth predetermined adjustment signals to the second circuit board 701. Then the second circuit board 701 controls the second motor 702, which drives the clamp 80 to raise or lower the image capturing device 200 using the second drive gear 703. Details will be given in the following paragraphs.

In one embodiment, the capturing system 10 includes a setting module 11, a receiving module 12, a displaying module 13, a controlling module 14, an adjusting module 15 and a stitching module 16. The modules 11-16 may comprise computerized instructions in the form of one or more programs that are stored in the storage device 20 and executed by the at least one processor 30. A detailed description of each module will be given in the following paragraphs.

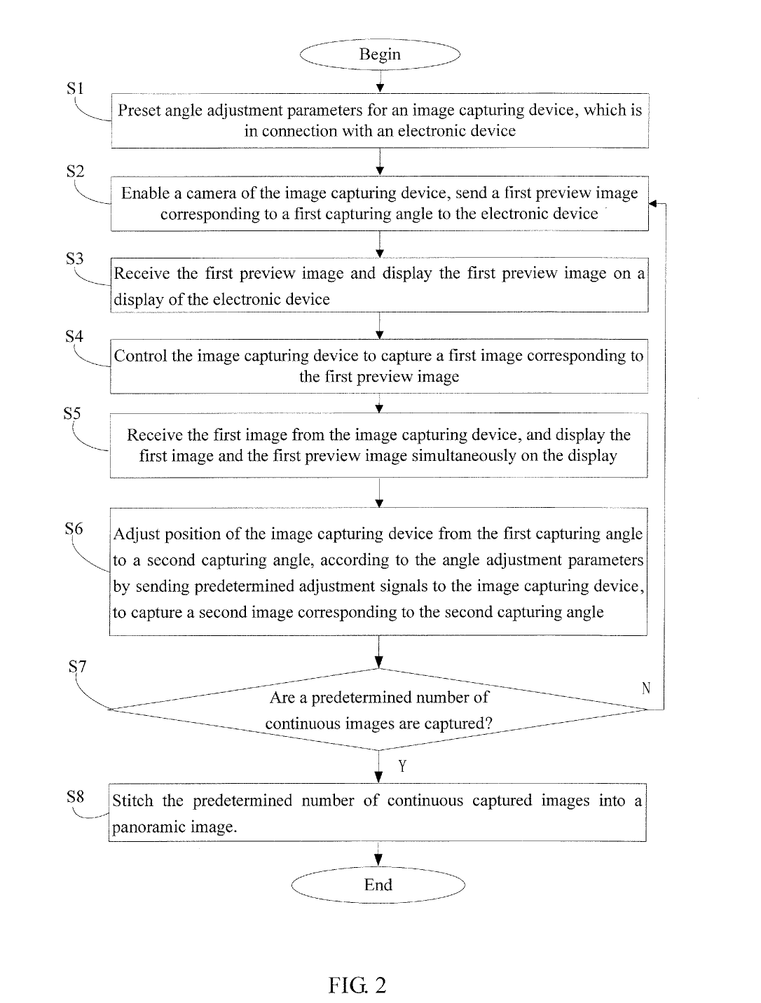

FIG. 2 is a flowchart of one embodiment of a method for capturing a panoramic image. Depending on the embodiment, additional steps may be added, others removed, and the ordering of the steps may be changed.

In step S1, the setting module 11 presets angle adjustment parameters for the image capturing device 200, which is in electronic connection with the electronic device 100. In one embodiment, the angle adjustment parameters includes a first angle of rotating the image capturing device 200 clockwise around the Y-axis, a second angle of rotating the image capturing device 200 counterclockwise around the Y-axis, a third angle of raising the image capturing device 200, and a fourth angle of lowering the image capturing device 200.

For example, the setting module 11 presets the first angle to be 1 degree, and presets the second angle to be 0.1 degree to conduct fine tuning. The setting module 11 further presets the third angle to be 1 degree, and presets the fourth angle to be 0.1 degree to conduct fine tuning. Details will be give in the below paragraphs.

In step S2, the camera 201 is enabled by a user, and the image capturing device 200 obtains a first preview image corresponding to a first capturing angle from the camera 201. The image capturing device 200 sends the first preview image to the electronic device 100.

In step S3, the receiving module 12 receives the first preview image from the image capturing device 200, and the displaying module 13 displays the first preview image on the display 40.

In step S4, the controlling module 14 controls the image capturing device 200 to capture a first image corresponding to the first preview image. For example, the image capturing device 200 captures a first image A corresponding to the first preview image, and sends the first image A to the electronic device 100.

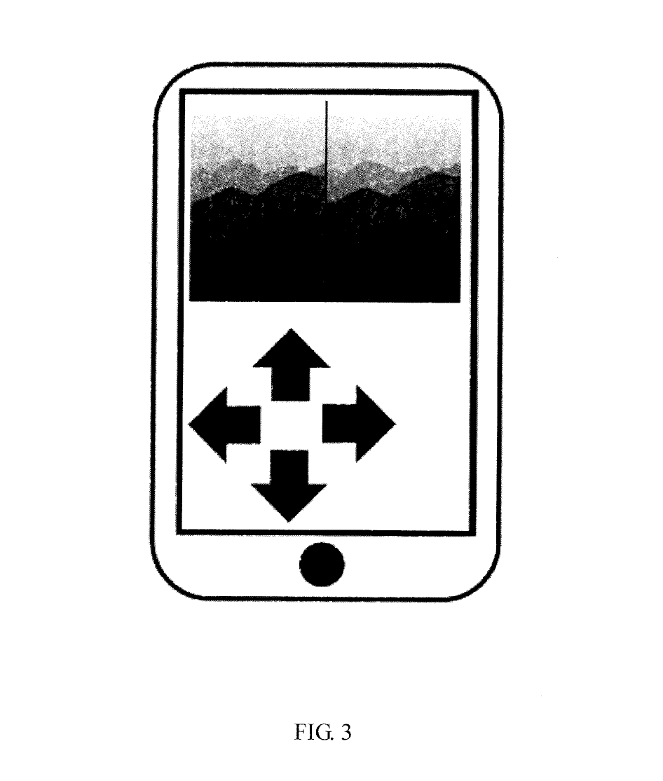

In step S5, the receiving module 12 receives the first image from the image capturing device 200, and the displaying module 13 displays the first image and the first preview image simultaneously on the display 40. For example, as shown in FIG. 3, the displaying module 13 displays the first image A on the left of the display 40, and displays the first preview image on the right of the display 40 simultaneously.

In step S6, the adjusting module 15 adjusts position of the image capturing device 200 from the first capturing angle to a second capturing angle, according to the angle adjustment parameters by sending predetermined adjustment signals to the image capturing device 200.

In one embodiment, the predetermined adjustment signals includes the first predetermined adjustment signal of rotating the image capturing device 200 clockwise, and the second predetermined adjustment signal of rotating the image capturing device 200 counterclockwise. The predetermined adjustment signals further include the third predetermined adjustment signal of raising the image capturing device 200, and the fourth predetermined adjustment signal of lowering the image capturing device 200.

In one embodiment, as shown in FIG. 3, the adjusting module 15 generates a right arrow key on the display 40 for the user to control the electronic device 100 to send the first predetermined adjustment signal, and generates a left arrow key to send the second predetermined adjustment signal to the image capturing device 200. The adjusting module 15 further generates an up arrow key for the user to control the electronic device 100 to send the third predetermined adjustment signal, and generates a down arrow key to send the fourth predetermined adjustment signal to the image capturing device 200. For example, if a user enters the right arrow key, the adjusting module 15 sends the first predetermined adjustment signal to the image capturing device 200.

In one embodiment, when the adjusting module 15 sends the first and the second predetermined adjustment signals to the image capturing device 200, the signal transmitting device 202 transmits the first and the second predetermined adjustment signals to the first direction controlling device 60. When the adjusting module 15 sends the third and the fourth predetermined adjustment signals to the image capturing device 200, the signal transmitting device 202 transmits the third and the fourth predetermined adjustment signals to the second direction controlling device 60.

As shown in FIG. 3, the displaying module 13 simultaneously displays the first image A on the left of the display 40 and displays the first preview image corresponding to the first capturing angle on the right of the display 40. When the electronic device 100 needs to obtain a second image corresponding to the second capturing angle, the adjusting module 15 sends the predetermined adjustment signals to the image capturing device 200, to adjust the image capturing device 200 from the first capturing angle to the second capturing angle.

For example, the adjusting module 15 sends the first predetermined adjustment signal to the image capturing device 200, when the image capturing device 200 receives the first predetermined adjustment signal, the signal transmitting device 202 transmits the first predetermined adjustment signal to the first circuit board 60 of the first direction controlling device 60, then the first circuit board 601 controls the first motor 602, which drives the main part 901 to rotate the image capturing device 200 around the Y-axis clockwise, according to the first angle (e.g., 1 degree) using the first drive gear 603.

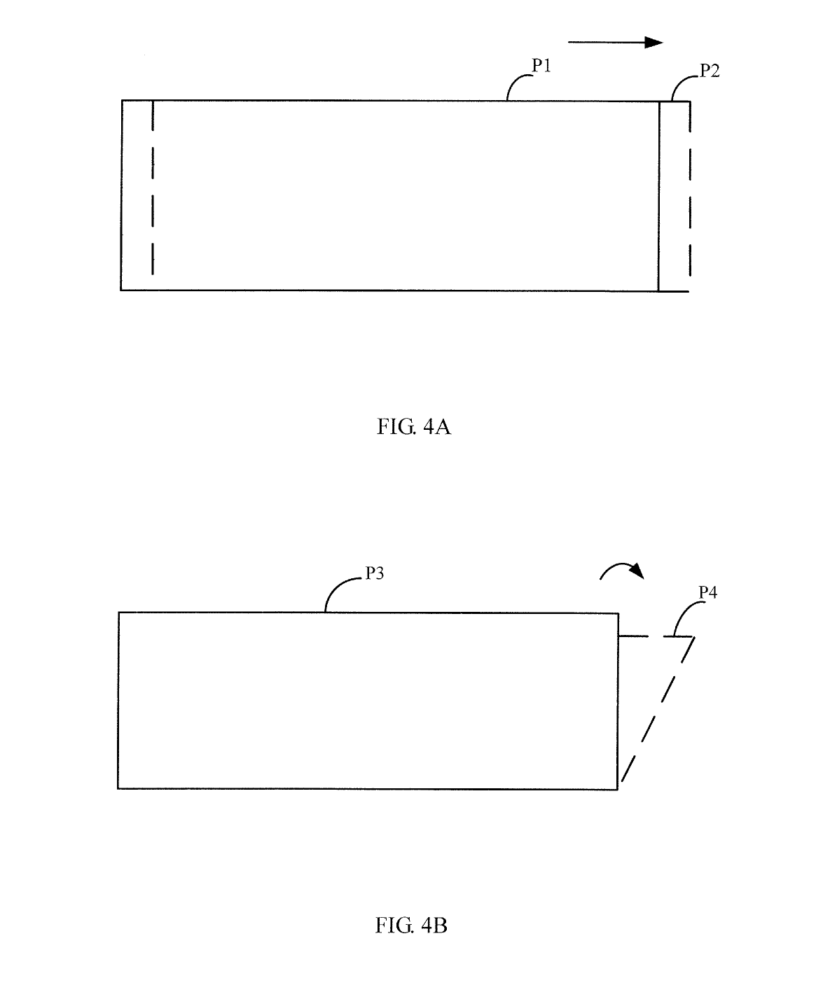

As shown in FIG. 4A, assuming that the current preview image corresponding to the first capturing angle is P1, when the first circuit board 601 controls the first motor 602, which drives the main part 901 to rotate the image capturing device 200 around the Y-axis clockwise, according to the first angle (e.g., 1 degree) using the first drive gear 603, then the current preview image is changed from P1 to P2.

It should be noted that, if the first angle is preset to be too large, the image capturing device 200 may be over-rotated clockwise, and it may result in the second image corresponding to the current preview image cannot be stitched with the first image. If this situation is happened, the adjusting module 15 can send the second adjustment signal to the image capturing device 200 to conduct the fine tuning.

For example, the transmitting module 202 transmits the second adjustment signal to the first circuit board 601 of the first direction controlling device 60, when the image capturing device 200 receives the second adjustment signal from the adjusting module 15, then the first circuit board 601 controls the first motor 602, which drives the main part 901 to rotate the image capturing device 200 around the Y-axis counterclockwise according to the second angle (e.g., 0.1 degree) using the first drive gear 603.

In other embodiments, if the current preview image of the image capturing device 200 is supposed to be P3 as shown in FIG. 4B, because of a vibration or other factors of the tripod 90, the current preview image of the image capturing device 200 is changed to be P4, then the adjusting module 15 can send the third adjustment signal to the image capturing device 200.

For example, when the image capturing device 200 receives the third predetermined adjustment signal from the adjusting module 15, the signal transmitting device 202 transmits the third predetermined adjustment signal to the second circuit board 701 of the second direction controlling device 70. Then the second circuit board 701 controls the second motor 702, which drives the clamp 80 to raise the image capturing device 200 according to the third angle (e.g., 1 degree) using the second drive gear 703.

Similarly, if the third angle is preset to be too large, the image capturing device 200 may be over-raised, and it may result in the second image corresponding to the current preview image cannot be stitched with the first image. If this situation is happened, the adjusting module 15 can send the fourth adjustment signal to the image capturing device 200 to conduct the fine tuning.

For example, when the image capturing device 200 receives the fourth adjustment signal from the adjusting module 15, the transmitting module 202 transmits the fourth adjustment signal to the second circuit board 701 of the second direction controlling device 70. Then the second circuit board 701 controls the second motor 702, which drives the clamp 80 to lower the image capturing device 200 according to the fourth angle (e.g., 0.1 degree) using the second drive gear 703.

After executing the above steps, the adjusting module 15 adjusts position of the image capturing device 200 from the first capturing angle to the second capturing angle, according to the angle adjustment parameters by sending predetermined adjustment signals to the image capturing device 200. Then the second image corresponding to the second capturing angle can be captured by the controlling module 14.

In step S7, the stitching module 16 determines whether the electronic device 100 acquires a predetermined number of continuous images that are captured by the image capturing device 200 at a predetermined number of continuous capturing angles. If the electronic device 100 acquires the predetermined number of continuous images, the process goes to step S8, if the electronic device 100 does not acquire the predetermined number of continuous images, the process goes back to Step S2.

In step S8, the stitching module 16 stitches the predetermined number of continuous captured images to be a panoramic image. For example, if the predetermined number of continuous images includes a first image A and a second image B, then the stitching module 16 stitches the right of the first image A to the left of the second image B to be a panoramic image.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display;
at least one processor; and
a storage device storing one or more computer-readable programs, which when executed by the at least one processor, causes the at least one processor to:
(a) preset angle adjustment parameters for an image capturing device in electronic connection with the electronic device;
(b) receive, from the image capturing device, a first preview image corresponding to a first capturing angle of the image capturing device;
(c) display the first preview image on the display;
(d) control the image capturing device to capture a first image corresponding to the first preview image;
(e) receive the first image from the image capturing device;
(f) display the first image and the first preview image on the display simultaneously;
(g) adjust position of the image capturing device from the first capturing angle to a second capturing angle according to the angle adjustment parameters;
(h) repeat step (b) to step (g) until the image capturing device acquires a predetermined number of continuous images captured by the image capturing device at a predetermined number of continuous capturing angles; and
(i) stitch the predetermined number of continuous captured images into a panoramic image.

2. The electronic device according to claim 1, wherein the position of the image capturing device is adjusted according to a first predetermined adjustment signal of rotating the image capturing device clockwise, and a second predetermined adjustment signal of rotating the image capturing device counterclockwise.

3. The electronic device according to claim 2, wherein the image capturing device is fixed to a tripod by a clamp, a signal transmitting device of the image capturing device is connected to a first direction controlling device of the tripod, the first direction controlling device comprising a first circuit board, a first motor, and a first drive gear connected to a main part of the tripod.

4. The electronic device according to claim 3, wherein when the image capturing device receives the first or the second predetermined adjustment signal from the electronic device, the signal transmitting device transmits the first and the second predetermined adjustment signals to the first circuit board, the first circuit board controls the first motor, which drives the main part to change position of the image capturing device from the first capturing angle to the second capturing angle using the first drive gear.

5. The electronic device according to claim 3, wherein the position of the image capturing device is further adjusted according to a third predetermined adjustment signal of raising the image capturing device, and a fourth predetermined adjustment signal of lowering the image capturing device.

6. The electronic device according to claim 5, wherein the signal transmitting device is further connected to a second direction controlling device of the tripod, the second direction controlling device comprises a second circuit board, a second motor, and a second drive gear connected to the clamp, when the image capturing device receives the third or the fourth predetermined adjustment signals from the electronic device, the signal transmitting device controls the second motor to drive the clamp to change the position of image capturing device from the first capturing angle to the second capturing angle using the second drive gear.

7. A method for capturing a panoramic image by using an electronic device, the electronic device comprising a display, the method comprising:
(a) presetting angle adjustment parameters for an image capturing device in electronic connection with the electronic device;
(b) receiving, from the image capturing device, a first preview image corresponding to a first capturing angle of the image capturing device;
(c) displaying the first preview image on the display;
(d) controlling the image capturing device to capture a first image corresponding to the first preview image;
(e) receiving the first image from the image capturing device;
(f) displaying the first image and the first preview image on the display simultaneously;
(g) adjusting position of the image capturing device from the first capturing angle to a second capturing angle according to the angle adjustment parameters;
(h) repeating step (b) to step (g) until the image capturing device acquires a predetermined number of continuous images captured by the image capturing device at a predetermined number of continuous capturing angles; and
(i) stitching the predetermined number of continuous captured images into a panoramic image.

8. The method according to claim 7, wherein the position of the image capturing device is adjusted according to a first predetermined adjustment signal of rotating the image capturing device clockwise, and a second predetermined adjustment signal of rotating the image capturing device counterclockwise.

9. The method according to claim 8, wherein the image capturing device is fixed to a tripod by a clamp, a signal transmitting device of the image capturing device is connected to a first direction controlling device of the tripod, the first direction controlling device comprising a first circuit board, a first motor, and a first drive gear connected to a main part of the tripod.

10. The method according to claim 9, wherein when the image capturing device receives the first or the second predetermined adjustment signal from the electronic device, the signal transmitting device transmits the first and the second predetermined adjustment signals to the first circuit board, the first circuit board controls the first motor, which drives the main part to change position of the image capturing device from the first capturing angle to the second capturing angle using the first drive gear.

11. The method according to claim 9, wherein the position of the image capturing device is further adjusted according to a third predetermined adjustment signal of raising the image capturing device, and a fourth predetermined adjustment signal of lowering the image capturing device.

12. The method according to claim 11, wherein the signal transmitting device is further connected to a second direction controlling device of the tripod, the second direction controlling device comprises a second circuit board, a second motor, and a second drive gear connected to the clamp, when the image capturing device receives the third or the fourth predetermined adjustment signals from the electronic device, the signal transmitting device controls the second motor to drive the clamp to change the position of image capturing device from the first capturing angle to the second capturing angle using the second drive gear.

13. A non-transitory storage medium having stored thereon instructions that, when executed by at least one processor of an electronic device, cause the processor to perform a method for capturing a panoramic image, the electronic device comprising a display, the method comprising:
(a) presetting angle adjustment parameters for an image capturing device in electronic connection with the electronic device;
(b) receiving, from the image capturing device, a first preview image corresponding to a first capturing angle of the image capturing device;
(c) displaying the first preview image on the display;
(d) controlling the image capturing device to capture a first image corresponding to the first preview image;
(e) receiving the first image from the image capturing device;
(f) displaying the first image and the first preview image on the display simultaneously;
(g) adjusting position of the image capturing device from the first capturing angle to a second capturing angle according to the angle adjustment parameters;
(h) repeating step (b) to step (g) until the image capturing device acquires a predetermined number of continuous images captured by the image capturing device at a predetermined number of continuous capturing angles; and
(i) stitching the predetermined number of continuous captured images into a panoramic image.

14. The non-transitory storage medium according to claim 13, wherein the position of the image capturing device is adjusted according to a first predetermined adjustment signal of rotating the image capturing device clockwise, and a second predetermined adjustment signal of rotating the image capturing device counterclockwise.

15. The non-transitory storage medium according to claim 14, wherein the image capturing device is fixed to a tripod by a clamp, a signal transmitting device of the image capturing device is connected to a first direction controlling device of the tripod, the first direction controlling device comprising a first circuit board, a first motor, and a first drive gear connected to a main part of the tripod.

16. The non-transitory storage medium according to claim 15, wherein when the image capturing device receives the first or the second predetermined adjustment signal from the electronic device, the signal transmitting device transmits the first and the second predetermined adjustment signals to the first circuit board, the first circuit board controls the first motor, which drives the main part to change position of the image capturing device from the first capturing angle to the second capturing angle using the first drive gear.

17. The non-transitory storage medium according to claim 15, wherein the position of the image capturing device is further adjusted according to a third predetermined adjustment signal of raising the image capturing device, and a fourth predetermined adjustment signal of lowering the image capturing device.

18. The non-transitory storage medium according to claim 17, wherein the signal transmitting device is further connected to a second direction controlling device of the tripod, the second direction controlling device comprises a second circuit board, a second motor, and a second drive gear connected to the clamp, when the image capturing device receives the third or the fourth predetermined adjustment signals from the electronic device, the signal transmitting device controls the second motor to drive the clamp to change the position of image capturing device from the first capturing angle to the second capturing angle using the second drive gear.
